(19) United States
(12) Patent Application Publication
(10) Pub. No.: US 2024/0219747 A1
(43) Pub. Date: Jul. 4, 2024

(54) EYEGLASS RETAINER

(71) Applicant: Gogglesoc Apparel Limited, Squamish (CA)

(72) Inventors: Peter Hill, Garibaldi Highlands (CA); Zachary Goldberg-Poch, Squamish (CA); Matthew Danchuk, VanCouver (CA)

(73) Assignee: Gogglesoc Apparel Limited, Squamish (CA)

(21) Appl. No.: 18/091,609

(22) Filed: Dec. 30, 2022

(51) Int. Cl. G02C 3/00; G02C 11/02

(52) U.S. Cl. CPC G02C 3/003; G02C 3/006; G02C 11/02

(57) ABSTRACT

An eyeglass retainer comprising a first cinch and a second cinch, the first cinch and second cinch each comprising a base with a first wall emanating up from the base forming a closed compartment, the first wall having an inner surface and an outer surface, a second wall emanating from the outer surface of the first wall, the second wall forming an aperture lateral of the closed compartment, the second wall having an inner surface and an outer surface and a lace having a body, a first end, a second end, the first end passing through the aperture of the first cinch and engaging with the closed compartment of the first cinch, forming a first loop, the second end passing through the aperture of the second cinch and engaging with the closed compartment of the second cinch, forming a second loop.

### FIELD OF INVENTION

The present invention relates to eyeglass retainers used to secure a pair of eyeglasses to the head or neck of the wearer. More specifically, the present invention relates to an improved system to maintain the strap of an eyeglass retainer in several fixed positions, so the strap does not interfere with the head or neck of the wearer.

### BACKGROUND OF THE INVENTION

A significant portion of the world's population carries sunglasses, eyeglasses, or both with them for use when needed. Eyeglasses/sunglasses are also easily dropped or misplaced leading to the wearer damaging or losing an often expensive and necessary accessory. Because of this, eyeglass/sunglass retainers of various components and configurations are well known in the art. Numerous retention devices work well in many cases, but attractive, low cost, and efficient retention devices which will comfortably hold the eyeglasses/sunglasses in position for use are still desired.

Thus, there remains a current need for an eyeglass/sunglass retainer to maintain the strap of an eyeglass/sunglass retainer in a desired fixed position, so the strap does not interfere with the head or neck of the wearer.

### SUMMARY

An eyeglass retainer comprising a first cinch and a second cinch, the first cinch and second cinch each comprising a base with a first wall emanating up from the base forming a closed compartment, the first wall having an inner surface and an outer surface, a second wall emanating from the outer surface of the first wall, the second wall forming an aperture lateral of the closed compartment, the second wall having an inner surface and an outer surface and a lace having a body, a first end, a second end, the first end passing through the aperture of the first cinch and engaging with the closed compartment of the first cinch, forming a first loop, the second end passing through the aperture of the second cinch and engaging with the closed compartment of the second cinch, forming a second loop.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a perspective view of one embodiment of the instant invention.

FIG. 2 is a perspective view of one embodiment of the instant invention.

FIG. 3 is a perspective view of one embodiment of the instant invention secured to a pair of sunglasses/eyeglasses.

FIG. 4A is a side view of an embodiment of one component of the instant invention.

FIG. 4B is a front view of an embodiment of one component of the instant invention.

FIG. 4C is a top view of an embodiment of one component of the instant invention.

FIG. 4D is a perspective view of an embodiment of one component of the instant invention.

FIG. 5 is a perspective view of an embodiment of one component of the instant invention.

FIG. 6 is a perspective view of an embodiment of one component of the instant invention.

FIG. 7A is a top view of an embodiment of one component of the instant invention.

FIG. 7B is a bottom view of an embodiment of one component of the instant invention.

FIG. 7C is a perspective view of an embodiment of one component of the instant invention.

FIG. 7D is a side view of an embodiment of one component of the instant invention.

FIG. 7E is a side view of an embodiment of one component of the instant invention.

FIG. 7F is a side view of an embodiment of one component of the instant invention.

FIG. 8 is a perspective view of one embodiment of the instant invention secured to a pair of sunglasses/eyeglasses.

FIG. 9 is a perspective view of an embodiment of one component of the instant invention.

FIG. 10 is a side view of an embodiment of one component of the instant invention.

FIG. 11 is a side view of an embodiment of one component of the instant invention.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The instant invention discloses an eyeglass retainer 5 comprising a first cinch 40A and a second cinch 40B, the first cinch 40A and second cinch 40B each comprising a base 41 with a first wall 42 emanating up from the base 41 forming a closed compartment 43, the first wall 42 having an inner surface 44 and an outer surface 45. A second wall 46 emanates from the outer surface 45 of the first wall 42, the second wall 46 forming an aperture 47 lateral of the closed compartment 43, the second wall 46 having an inner surface 48 and an outer surface 49. The invention further includes a lace 10 having a body 11, a first end 13, and a second end 16, the first end 12 passing through the aperture 47 of the first cinch 40A and engaging with the closed compartment 43 of the first cinch 40A, forming a first loop 55A, and the second end 16 passing through the aperture 47 of the second cinch 40B and engaging with the closed compartment 43 of the second cinch 40B, forming a second loop 55B.

Looking more closely at the figures, there is illustrated a cinch 40 which are generally used in pairs in the instant invention. Each cinch 40 includes a base 41 with a first wall 42 emanating up from the base 41 forming a closed compartment 43 with the base 41 acting as a barrier. The first wall includes an inner surface 44 and an outer surface 45. A second wall 46 emanates from the outer surface 45 of the first wall 42 in the form of a ring with an inner surface 48 and an outer surface 49, the second wall 46 forming an aperture 47 lateral of the closed compartment 43. Each cinch is formed from a soft flexible material, a hard rigid material, or a combination thereof. Each cinch can be formed from metals, plastics, resins, rubbers, or a combination thereof.

Looking again to the figures, there is illustrated a lace 10 which includes a body 11 with a first side 12 on which a first end 13 is located, and a second side 15 on which a second end 16 is located. The lace 10 is formed from a material which is flexible, semi rigid, rigid, or a combination thereof. The lace 10 is formed from a material which is flat, round, or a combination thereof. The lace 10 is formed from a material which is woven, solid, non-woven, or a combination thereof. The lace 10 can be constructed from a material which is natural (cotton, wool, etc.), synthetic (polyester, nylon, etc.), or a combination thereof. When constructed, the eyeglass retainer 5 includes a lace 10 as described previously, the first end 13 passing through the aperture 47 of a first cinch 40A, folding over to be inserted into the closed compartment 43 of the first cinch 40A, with the folded section of the lace 10 forming a first loop 55A. The second end 16 of the lace 10 passing through the aperture 47 of a second cinch 40B, folding over to be inserted into the closed compartment 43 of the second cinch 40B, with the folded section of the lace 10 forming a second loop 55B. The sides 12, 15 of the lace 10 are slidingly engaged with the apertures 47 of their respective cinch 40A, 40B. The apertures 47 are generally smaller in diameter opening than the cross section of the lace 10 so as to maintain the tightness of each loop 55A, 55B as they encircle the temple 73 of a pair of eyeglasses. Each temple 73 is trapped between the lace 10 and the side of the cinch 40 holding the temple 73 tightly. The ends 13, 16, are generally permanently attached to the closed compartment 43 into which each is inserted, but may be releasably attached. Permanent attachment can be achieved through insert molding the two components together, gluing, thermal bonding, or any other method known in the art.

The eyeglass retainer may also include a bead 20 slidingly engaged to the body 11 of the lace 10 wherein the bead 20 may be used to tighten or loosen the lace 10 from a user's head. Put another way, the bead 20 slides up and down the lace 10 to adjust the length of the lace 10 on the user's body. Together, the lace 10 holds the glasses 70 tight to the user's head when the bead 20 is pulled tight, or allows the glasses 70 to hang loose around the user's neck. Each bead 20 generally includes a body 24 with an aperture 23 extending completely through the body which has an inner surface 21 and an outer surface 22. The lace 10 is generally folded and inserted through the aperture 23 of the bead 20, slidingly engaging the inner surface 21 of the bead. As with the aperture 47 of the cinch 40, the aperture 23 of the bead 20 is generally smaller in diameter opening than the cross section of the lace (folded or not folded) so as to maintain the tightness of the bead 20 on the lace 10. The bead 20 is formed from a soft flexible material, a hard rigid material, or a combination thereof. Each bead 20 can be formed from metals, plastics, resins, rubbers, or a combination thereof.

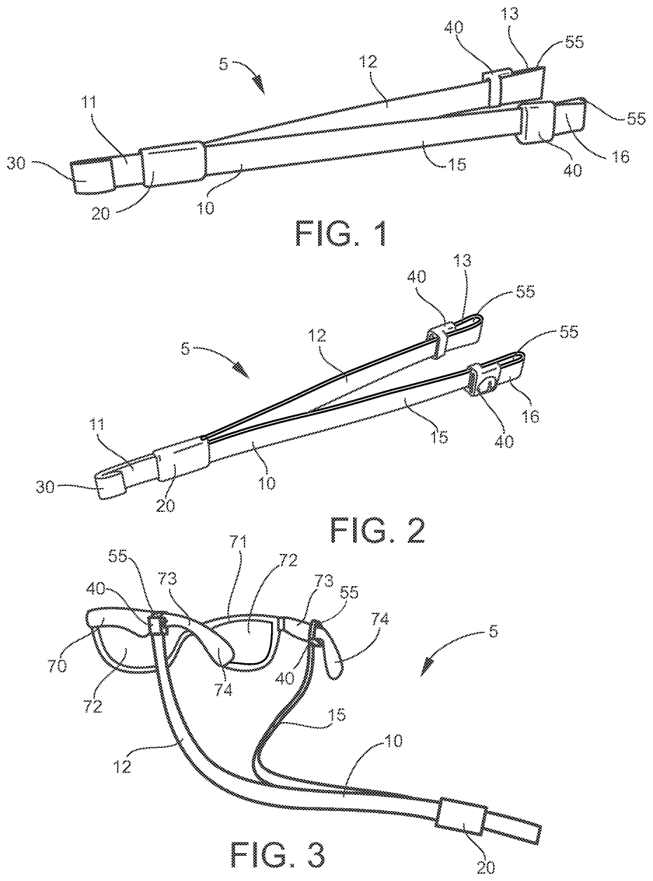

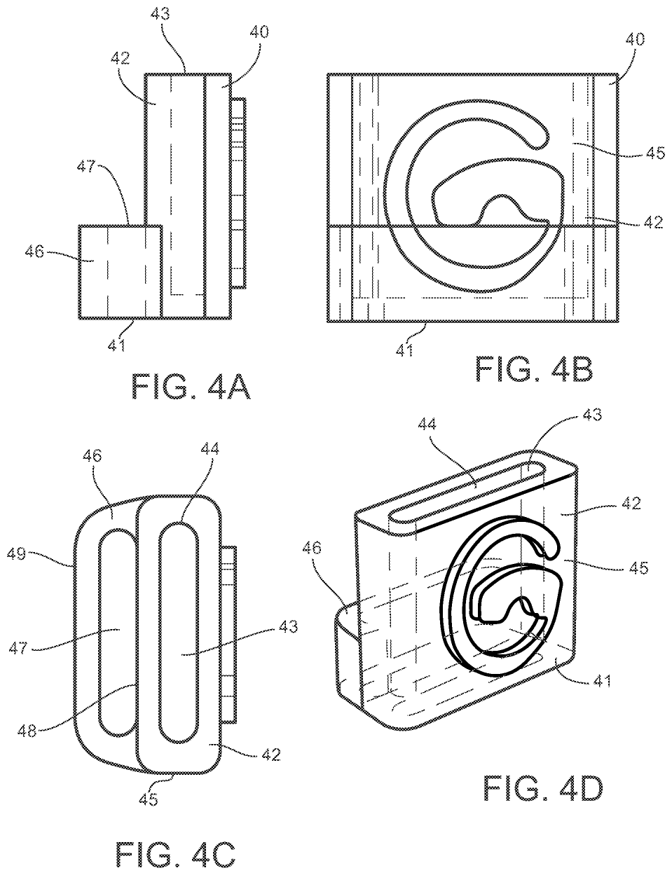

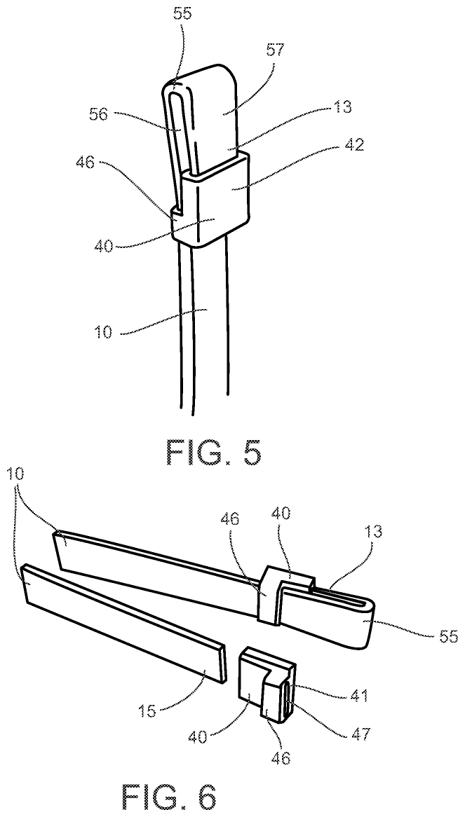

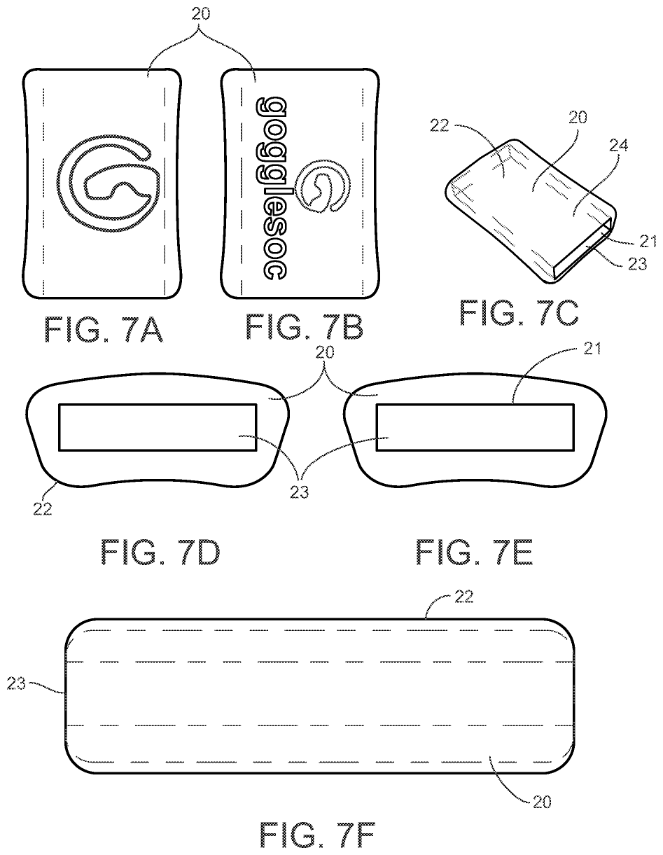

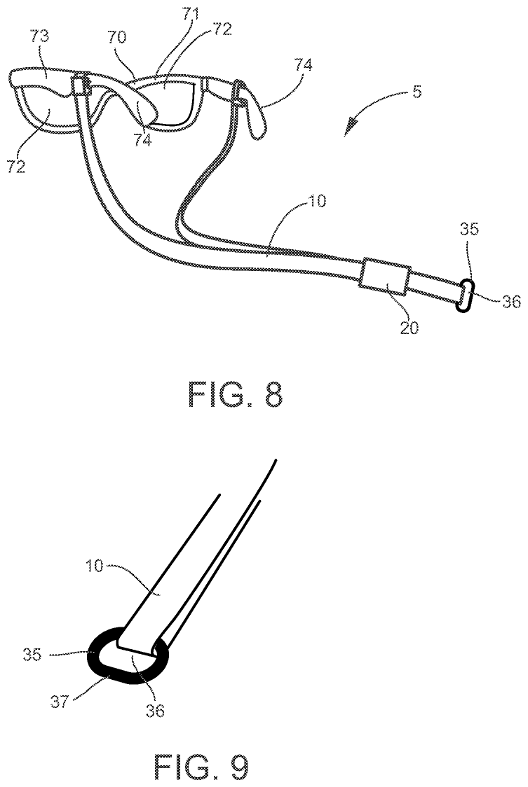

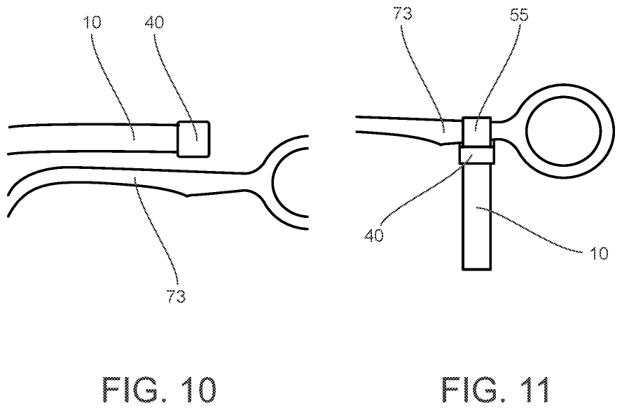

The eyeglass retainer may also include a bead retainer 30 located on the body 11 of the lace 10. The bead retainer is selected from the group including a ring 35 (FIG. 8 and FIG. 9), a folded section of the lace (folded an additional time than described as being folded and inserted into the bead above (see FIG. 1 and FIG. 2)), an additional material secured to the body of the lace, or a combination thereof. When the bead retainer is created with a second material, the material can be flexible or rigid and the material is attached to the lace in a permanent fashion by being glued, sewn, bonded, riveted, or the like. The ring 35 generally has an aperture 36 and a body 37. The lace 10 runs through the aperture 36 of the ring 35 and the ring is then located at the approximate center of the lace 10. The ring 35 is larger than the bead 20 so as to prevent the bead from coming off of the lace 10. Each ring 35 is formed from a soft flexible material, a hard rigid material, or a combination thereof. Each ring 35 can be formed from metals, plastics, resins, rubbers, or a combination thereof.

The instant invention also includes an eyeglass retainer 5 comprising a first cinch 40A and a second cinch 40B, the first cinch and second cinch each comprising a base 41 with a first wall 42 emanating up from the base 41 forming a closed compartment 43, the first wall 42 having an inner surface 44 and an outer surface 45, a second wall 46 emanating from the outer surface 45 of the first wall 42, the second wall 46 forming an aperture 47 lateral of the closed compartment 43, the second wall 46 having an inner surface 48 and an outer surface 49. The eyeglass retainer 5 also includes a lace 10 having a body 11, a first end 13, a second end 16, with the first end 13 passing through the aperture 47 of the first cinch 40A and engaging with the closed compartment 43 of the first cinch 40A, forming a first loop 55A, and the second end 16 passing through the aperture 47 of the second cinch 40B and engaging with the closed compartment 43 of the second cinch 40B, forming a second loop 55B. A bead 20 is slidingly engaged to the body 11 of the lace 10 wherein the bead 20 may be used to tighten or loosen the lace 10 from a user's head and a bead retainer 30 located on the body 11 of the lace 10, the bead retainer 30 being selected from the group including a ring 35, a folded section of the lace, an additional material secured to the body of the lace, or a combination thereof. This embodiment can include any of the elements previously described.

In the instant invention, eyeglasses refer to any type of eyewear known in the art including both eyeglasses for improved, clarified, and corrected vision, as well as sunglasses. The eyeglass retainer of the instant invention is designed to work with eyeglasses/sunglasses 70 which include a main frame 71 with one or more lenses 72, a pair of temples 73 secured by one end to the main frame, with the opposite end being an ear retainer 74.

Any method described herein may incorporate any design element contained within this application and any other document/application incorporated by reference herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present invention may be embodied in other forms without departing from the spirit and the essential attributes thereof, and, accordingly, reference should be made to the appended claims, rather than to the foregoing specification, as indicating the scope of the invention. The invention illustratively disclosed herein suitably may be practiced in the absence of any element which is not specifically disclosed herein.

1. An eyeglass retainer comprising
a first cinch and a second cinch, the first cinch and second cinch each comprising:
a base with a first wall emanating up from the base forming a closed compartment, the first wall having an inner surface and an outer surface;
a second wall emanating from the outer surface of the first wall, the second wall forming an aperture lateral of the closed compartment, the second wall having an inner surface and an outer surface; and
a lace having a body, a first end, a second end;
the first end passing through the aperture of the first cinch and engaging with the closed compartment of the first cinch, forming a first loop;
the second end passing through the aperture of the second cinch and engaging with the closed compartment of the second cinch, forming a second loop.

2. The eyeglass retainer of claim 1 further comprising:
a bead slidingly engaged to the body of the lace wherein the bead may be used to tighten or loosen the lace from a user's head.

3. The eyeglass retainer of claim 2 further comprising:
a bead retainer located on the body of the lace, the bead retainer being selected from the group including a ring, a folded section of the lace, an additional material secured to the body of the lace, or a combination thereof.

4. The eyeglass retainer of claim 2 wherein
the bead is formed from a soft flexible material, a hard rigid material, or a combination thereof.

5. The eyeglass retainer of claim 1 wherein
each cinch is formed from a soft flexible material, a hard rigid material, or a combination thereof.

6. The eyeglass retainer of claim 1 wherein
the lace is formed from a material which is flexible, semi rigid, rigid, or a combination thereof.

7. The eyeglass retainer of claim 1 wherein
the lace is formed from a material which is flat, round, or a combination thereof.

8. The eyeglass retainer of claim 1 wherein
the lace is formed from a material which is woven, solid, non-woven, or a combination thereof.

9. An eyeglass retainer comprising
a first cinch and a second cinch, the first cinch and second cinch each comprising:
a base with a first wall emanating up from the base forming a closed compartment, the first wall having an inner surface and an outer surface;
a second wall emanating from the outer surface of the first wall, the second wall forming an aperture lateral of the closed compartment, the second wall having an inner surface and an outer surface;
a lace having a body, a first end, a second end;
the first end passing through the aperture of the first cinch and engaging with the closed compartment of the first cinch, forming a first loop;
the second end passing through the aperture of the second cinch and engaging with the closed compartment of the second cinch, forming a second loop.
a bead slidingly engaged to the body of the lace wherein the bead may be used to tighten or loosen the lace from a user's head; and
a bead retainer located on the body of the lace, the bead retainer being selected from the group including a ring, a folded section of the lace, an additional material secured to the body of the lace, or a combination thereof.

10. The eyeglass retainer of claim 9 wherein
the bead is formed from a soft flexible material, a hard rigid material, or a combination thereof.

11. The eyeglass retainer of claim 9 wherein
each cinch is formed from a soft flexible material, a hard rigid material, or a combination thereof.

12. The eyeglass retainer of claim 9 wherein
the lace is formed from a material which is flexible, semi rigid, rigid, or a combination thereof.

13. The eyeglass retainer of claim 9 wherein
the lace is formed from a material which is flat, round, or a combination thereof.

14. The eyeglass retainer of claim 9 wherein
the lace is formed from a material which is woven, solid, non-woven, or a combination thereof.
